(19) United States
(12) Patent Application Publication
(10) Pub. No.: US 2025/0250930 A1
(43) Pub. Date: Aug. 7, 2025

(54) Turbomachine for an Aircraft Engine

(71) Applicant: MTU Aero Engines AG, München (DE)

(72) Inventors: Istvan BOLGAR, Sengenthal (DE); Alexander WOITALKA, Munich (DE); Daniel GIZIK, Munich (DE)

(73) Assignee: MTU Aero Engines AG, München (DE)

(21) Appl. No.: 18/608,547

(22) Filed: Mar. 18, 2024

(30) Foreign Application Priority Data
Mar. 24, 2023 (DE) 10 2023 107 536.5
Jul. 7, 2023 (DE) 10 2023 118 104.1

(51) Int. Cl. F02C 3/30; F23R 3/00

(52) U.S. Cl. CPC F02C 3/30; F23R 3/005; F05D 2260/213

(57) ABSTRACT

The invention relates to a turbomachine for an aircraft propulsion drive with a compressor, through which a gas flow streams in a flow direction of the turbomachine, a combustion chamber, a turbine, and a heat exchanger downstream of the turbine, wherein the heat exchanger is set up to produce steam from water by energy from the gas flow, which, in particular, can be fed to the gas flow for combustion with fuel in the combustion chamber.

### BACKGROUND OF THE INVENTION

The invention relates to a turbomachine for an aircraft propulsion drive with a compressor through which a gas flow streams in a flow direction of the turbomachine, a combustion chamber, a turbine, and a heat exchanger downstream of the turbine, wherein the heat exchanger is set up to produce steam from water by energy from the gas flow and the steam can be fed, in particular, into the gas flow for combustion with fuel in the combustion chamber.

In order to improve the environmental impact of air traffic, efforts exist to utilize the medium water or steam for increasing power and lowering emissions. For example, the “water-enhanced turbofan (WET)” technology focuses on an injection of water into a combustion chamber. Steam can thereby be produced in a heat exchanger or steam generator arranged downstream of an engine turbine by exhaust gas energy and fed to the region of the combustion chamber. After flowing through the steam generator, moist exhaust gas can flow through further components, which serve to extract water from the exhaust gas. Fundamental prerequisites for these WET concepts are an efficient recovery of the water contained in the exhaust gas and an efficiency-optimized utilization of the energy present in the exhaust gas of the turbomachine for the production of steam from the recovered water. The vaporizer or heat exchanger is typically subjected here to a broad temperature range. In order to fulfill the material requirements, the heat exchanger is typically designed for maximally attainable temperatures. This can necessitate the utilization of a material with special properties, which, in turn, can lead to high material costs and/or a high total weight of the heat exchanger.

### SUMMARY OF THE INVENTION

Proceeding from this, an object of the present invention is to propose an improved turbomachine for an aircraft propulsion drive, in which, in particular, the weight and/or the efficiency of the turbomachine shall be improved. This is accomplished in accordance with the present invention. Advantageous embodiments of the invention are discussed in detail below.

Proposed for achieving said object is a turbomachine for an aircraft propulsion drive with a compressor through which a gas flow streams in a flow direction of the turbomachine, a combustion chamber, a turbine, and a heat exchanger downstream of the turbine, wherein the heat exchanger is set up to produce water by energy from the gas flow and the water can be fed, in particular, into the gas flow for combustion with fuel in the combustion chamber. In this case, the heat exchanger has at least one flow channel with at least two sections arranged parallel to one another, through which the water can flow, wherein the gas flow can stream at an angle around the at least two sections, which comprise different working materials.

Different working materials can thereby comprise, for example, different materials, alloys, thermal conductivities, heat transfer coefficients, temperature resistances, and/or densities, as a result of which a special adaptation to operating conditions is made possible for the respective sections. By way of the proposed solution, it is possible, for example, for sections of the at least one flow channel that are arranged in a region with a higher gas flow temperature to have a higher temperature resistance than sections that are arranged in a region with a lower gas flow temperature. Accordingly, not all sections need to be designed for the maximum temperature of the gas flow, which typically exists in the region lies closest to the turbine in the flow direction of the gas flow, but instead less temperature-exposed regions can comprise materials of lower density, for example, and thus, in particular, a lower weight. In this way, a total weight of the sections and thus of the heat exchanger and/or of the turbomachine can be reduced. This, in turn, can have an advantageous effect on an efficiency of the turbomachine.

Each of the fluid flows, that is, the water and the gas flow, can thereby stream or be carried with respect to each other in discrete flow pathways at an angle, in particular essentially at a right angle, as a result of which a heat transfer in the cross flow or cross counterflow of the water and of the gas flow can be created. In terms of the invention, cross flow is referring to that the two flows or substance flows stream with respect to each other at an angle that is essentially 90°, but, in particular, at least in regions, can deviate from this angle, in particular by up to plus/minus 10°, by up to plus/minus 20° and, in particular, by up to plus/minus 30°.

The at least two sections arranged parallel to one another can therefore extend in a plurality of parallel planes and can be connected to one another, so that the water can flow through the sections of the at least one flow channel one after the other. Accordingly, the water can flow or be fed in two adjacent sections in opposing direction. The flow occurs through parallel sections of each flow channel, in particular one after the other, in that, in particular, the gas flow occurs at predetermined angles with respect to the sections, as a result of which the water can form with the gas flow a flow configuration of a cross-counterflow heat exchanger. In one embodiment, the parallel axes of the sections can also coincide, so that the sections are arranged concentrically with respect to one another.

A turbomachine for an aircraft propulsion drive comprises a compressor, a combustion chamber, and a turbine. During the operation of the turbomachine, air is compressed in a compressor, mixed with fuel in the combustion chamber, and ignited in order to drive the turbine. Furthermore, the turbomachine can have a fuel processing system for processing the fuel prior to its combustion in the combustion chamber, whereby the combustion can use, in particular, the steam produced in the heat exchanger. The proposed turbomachine has, in addition, a heat exchanger arranged downstream of the turbine, in which, in particular, steam is produced from water extracted from the gas flow or the exhaust gas of the turbomachine and made available to the heat exchanger by use of the energy from the gas flow. In the scope of the present disclosure, the gas flow, after exiting the turbine, is referred to, in particular, also as exhaust gas or exhaust gas flow.

An aircraft propulsion drive can have such a turbomachine, in particular an axial turbomachine, whereby the turbomachine can have an exhaust gas treatment device, which is arranged, in particular, downstream of the turbine of the turbomachine. The exhaust gas treatment device can comprise a heat exchanger, a cooling device, and a water separating device. Downstream of the turbine, the gas flow can stream through the heat exchanger, the cooling device, and the water separating device one after the other or else the heat exchanger, the cooling device, and the water separating device can be arranged in the flow direction of the turbomachine at least in part at an exhaust gas channel of the exhaust gas treatment device. The gas flow after the turbine or an exhaust gas of the aircraft engine or of the turbine can be cooled by the heat exchanger to a temperature below its temperature upon exiting the turbine or else to an original exhaust gas temperature. Energy is hereby taken from the gas flow by the heat exchanger and is used for the production of steam, as a result of which the temperature of the gas flow drops.

The cooling device downstream of the heat exchanger in the flow direction can be designed here as a condenser (condenser heat exchanger) or can comprise such a condenser and can utilize surrounding air as cooling fluid, which, for example, is conveyed by a blower or a fan of the turbomachine. This condenser heat exchanger can have essentially two regions, whereby, in a first region arranged upstream, a cooling of the essentially gaseous exhaust gas flow takes place. In a second region downstream of the first region, the exhaust gas flow is (still) further cooled, so that liquid portions of water are present in the exhaust gas flow, which can be extracted from said exhaust gas flow. The liquid portion of water can be extracted from the gas flow in the water separating device and made available to the heat exchanger for the production of steam. The separated water can be made available to the steam generator or the heat exchanger by a feeding device, for example, whereby the water can be fed optionally via a water processing system to a water reservoir, where it can be available for a further use. Accordingly, the water that is to be fed or has been fed to the heat exchanger can be kept at least in part in circulation, as a result of which an additional water supply for the combustion process can be dispensed with.

At least a part of the steam produced in the heat exchanger can be carried, in particular, via a steam line or steam feed to a mixing chamber of a fuel processing system. Fuel can be introduced into this mixing chamber and thus be fed into the steam introduced there, whereby the fuel can vaporize. Accordingly, it is possible to form from the steam and the fuel a mixture that, finally, can be fed into the combustion chamber of the turbomachine for combustion. In many embodiments, the steam can also be fed into the gas flow in front of or in the combustion chamber.

The heat exchanger takes on essentially two functions in a turbomachine that utilizes the WET concept: on the one hand, energy is taken from the gas flow, as a result of which the temperature of the gas flow is reduced so as to enable the recovery of water from the gas flow, and, on the other hand, this energy is used in order to heat and/or to vaporize the water taken, in particular, from the gas flow in order to be able to use it for combustion in the combustion chamber.

Against this background, the invention is based on, among other things, the idea of designing a flow channel feed or substance flow feed in the heat-exchange region of the heat exchanger in such a way that a flow configuration of a cross-counterflow heat exchanger can be formed and, in turn, of utilizing this configuration in order to employ various materials, depending on the existing operating conditions, in particular the operating temperatures in various regions of the heat exchanger. Inside of the at least one flow channel, the water flows or streams, in particular in a cross counterflow relative to the exhaust gas or the gas flow that streams on the outside of the at least one flow channel, whereby the gas flow upstream, that is, coming from the turbine, typically has the highest temperature. Since the gas flow streams around or against the sections of the at least one flow channel, in particular one after the other, the sections situated upstream in the flow direction of the gas flow absorb energy and thus heat from the gas flow, as a result of which the gas flow, in turn, cools. The heat transfer between the gas flow and the water thereby occurs in the heat exchanger essentially by convection. The materials of the various sections can fulfill different material requirements and thus utilize the fact that, owing to the proposed flow configuration, sections situated (gas-) downstream of the at least one flow channel of a gas flow are exposed to lower temperature. Through the utilization of various materials, it is possible to take into account a relative temperature difference between the gas flow and the water that is to be vaporized in the sections with different materials in order to design efficiently a production of steam or a superheating of the steam produced in the heat exchanger. By way of the proposed design, the heat exchanger can be smaller in dimension and lighter, as a result of which a reduction in weight of the heat exchanger and thus of the turbomachine can be achieved. Viewed overall, it is possible in this way to design the turbomachine to be lighter in its entirety, as a result of which the aircraft generates less resistance to lift and/or air.

In one embodiment, the gas flow streams around the at least two sections one after the other at an angle of, in particular, about 90°. The specification “about” is intended to take into account the circumstance that, by way of restrictions of the gas flow feed owing to the design or flow influences, the gas flow can deviate from a 90° flow, in particular in regions. In this embodiment, it is essential that the heat transfer occurs according to the cross-flow principle. The direction of the gas flow thereby extends essentially perpendicular to the flow direction of the water, so that a flow configuration of a cross-counterflow heat exchanger ensues. This can be utilized in order for the gas flow to stream around the at least one flow channel in a uniform manner over its length extension and thereby make possible a homogeneous heat transfer. In this way, thermal loads inside a section of the at least one flow channel turn out to be identical or at least similar. The gas flow and the water can thus stream or flow at an angle of about 90° with respect to each other. Average deviations that are due to the flow and/or the design and are unavoidable comprise, in particular, partial deviations in the range up to plus/minus 10° all the way to plus/minus 30° from a 90° angle. Through the heat transfer in the cross flow, the water or the steam can be brought to a predetermined temperature in a more operationally safe and efficient manner. In other embodiments, the gas flow can stream around the at least two sections one after the other also at another angle than about 90°, in particular at an angle in the range of 45° to 90° or even at an angle of less than 45°.

In order to achieve a flow of the at least one flow channel that extends essentially perpendicular to the at least one flow channel by the gas flow, the heat exchanger can have a diverting device. It is hereby possible by the diverting device of the heat exchanger and/or in the heat-exchange region to achieve a diversion of the gas flow in relation to the flow direction or the main flow axis of the turbomachine in order to make possible a heat transfer in the cross flow or cross counterflow between the gas flow and the water flowing in the at least one flow channel. In this way, the flow distribution of the gas flow relative to the flow channels can be alike for each of the flow channels in order to prevent an aerothermal asymmetry.

In an embodiment, a section of the at least one flow channel that is arranged further upstream in the flow direction of the gas has a material with a higher density than a section arranged further downstream. When it exits the turbine and, in particular, when it exits a low-pressure turbine, the gas flow has a temperature of between 800 and 980 K. In the course of the gas flow, this initial temperature can decline owing to the release of energy to the water, whereby an initial temperature of the water can increase in the flow course of the flow channel. Such a section arranged further upstream in the flow direction of the gas flow is arranged typically at a downstream-most position in the flow course of the water in the flow channel, at which position the water can exist, in particular, already predominantly in a vaporous state. Because, when it enters the heat-exchange region, the gas flow has the hottest temperature and thus, in a region of the at least one flow channel that faces the entrance, can release the most energy or heat to the water flowing in a flow channel or to the steam, higher thermal loads exist in this region, for which reason, in particular, materials of higher density can be provided.

In an embodiment, a section of the at least one flow channel that is arranged further upstream in a flow direction of the water has a material with a lower density than a section arranged further downstream. Such a section arranged further upstream in the flow direction of the water is arranged typically in a downstream position in the flow direction of the gas flow at which the gas flow can already be cooled, in particular by the release of energy to the water. Usually, in such a region, lower thermal loads of a flow channel exist, for which reason materials of lower density can be provided. In this way, it is possible to achieve a weight saving in regions subject to less thermal load for the heat exchanger.

In an embodiment, the at least a flow channel has at least one structural element at its surface that faces the gas flow. A structural element can hereby be, for example, at least one smooth, corrugated, and/or cut lamella, at least one rib, and/or at least one differently formed secondary surface, which, in particular, has a good thermal conductivity. Because the flow of heat is obtained from the product of the heat transfer coefficient of the surface that is present and the temperature difference between the fluids, that is, the water and the gas flow, the side of the fluid without phase change, that is, the gas flow, in particular depending on the operating point, can represent the limiting side for the flow of heat. By way of the proposed solution, a surface of the at least one flow channel can be enlarged and the product of the surface and the heat transfer coefficient can thereby be adjusted to the product of surface and the heat transfer coefficient of a dominating inner flow channel side, that is, the water-carrying side, as a result of which an efficiency can be enhanced and an efficiency of the heat transfer can be increased.

In an embodiment, at least two flow channels are connected to one another through at least one structural element. It is hereby possible, for example, for one lamella or a plurality of lamellae to connect a plurality of flow channels and/or sections to one another, whereby the lamellae can be arranged, in particular, perpendicular to a flow course of the water. In other exemplary embodiments, the respective flow channels and/or sections can have one lamella or a plurality of lamellae arranged independently of one another and/or spaced apart with respect to one another. In this way, a surface for the beat exchange can be enlarged and, at the same time, a mechanical stability of the flow channel and thus of the heat exchanger can be improved.

In an embodiment, at least two sections of the at least one flow channel have different inner cross sections. An inner cross section is understood to mean, in particular, a tubular cross-sectional surface of a flow channel or of a section of the flow channel. It is hereby possible, for example, for parallel sections of the flow channel to be arranged in at least two arrangement planes, whereby sections of different arrangement planes can have different inner cross sections. Sections that are arranged in the flow direction of the gas flow upstream or closer to the turbine can hereby have a smaller or larger diameter than sections that are arranged downstream in the flow direction of the gas flow or further away from the turbine and/or closer to a feed of the water in the flow channel. Accordingly, it is possible, for example, for water in the liquid state to flow in sections of the flow channel with larger inner cross sections and, with increasing degree of vaporization, to flow in sections with smaller inner cross sections in order to counter a change in the Reynolds numbers during the vaporization of phase-changing water along the flow pathways. In this way, a ratio of heat transfer to pressure losses can be improved. In addition, it is possible to determine a tubular wall thickness of a section depending on a cross section and/or a material used in order to be able to achieve a further optimization of a heat exchange.

In an embodiment, at least two sections of the flow channel that are arranged parallel with respect to one another can be in fluid connection by a connecting device. It is hereby possible for the connecting device to be formed so as to make a fluid connection of at least two sections to one another, in particular sections arranged parallel and/or adjacent and/or concentrically with respect to one another, in particular of two or a plurality of arrangement planes, and to do so, in particular, without any impairment of the flow cross section or inner cross section. For example, the connecting device can be designed as a curved section, which can be designed integrally or as a separate component, as a manifold or ring distributor. In this way, the water flows through a flow channel in two adjacent sections, in particular in opposing directions, as a result of which the heat exchange in the cross counterflow can be made possible. In addition, a connection of parallel sections of a flow channel by one connecting device or a plurality of connecting devices is made possible, so that one section or a plurality of sections have different geometries and/or various materials.

In an embodiment, the connecting device is set up to divert water from one section of the flow channel into at least one adjacent section the flow channel. It is hereby possible for two parallel and/or adjacent sections of at least two arrangement planes, in particular, to connect or to be connected to one another, whereby a connection in the form of a tube-to-tube connection, for example, in particular a direct tube-to-tube connection, in particular in the form of one tubular transition piece or a plurality of tubular transition pieces, tubular bundles, a manifold or manifolds, and/or ring distributors, can be realized.

In an embodiment, a number of first sections differs from a number of second sections of the heat exchanger. In such an embodiment, the connecting device can be set up to collect water from sections of an arrangement plane arranged upstream in the flow direction of the water in a plenum and to carry it or to distribute it in sections of an arrangement plane that follows in the flow direction of the water. In this way, different numbers of sections of various arrangement planes, through which a flow can occur, can be connected and, at the same time, an intermixing of the water can be promoted.

In an embodiment, the at least one flow channel has a flow element. A flow element can hereby be, for example, an insert, which can be arranged in a cross section of the at least one flow channel through which a flow can stream. The flow element can hereby be designed as a constriction and/or a baffle and, for example, can be set up to reduce the inner cross section of the flow channel at least in sections in order to prevent or reduce instabilities in terms of fluid mechanics. In other embodiments, the flow element can be designed in a lattice structure, which, in particular, can be arranged in a vaporization region of the flow channel. Such a lattice structure can produce turbulences and an intermixing of the water or of the steam can be increased. In this way, it is possible, for example, to bring the droplets present in the water (steam) flow onto a wall of the flow channel or onto a part of the flow element that is connected to the wall in a thermally conductive manner, where so much thermal energy is supplied to them that they can vaporize. A capacity of the heat exchanger can be increased in this way.

Further features, advantages, and possible applications of the invention ensue from the following description in conjunction with the figures. In general, it holds that features of the various exemplary aspects and/or embodiments described herein can be combined with one another insofar as this is not explicitly excluded in connection with the disclosure.

### BRIEF DESCRIPTION OF THE DRAWING FIGURES

In the following part of the description, reference is made to the figures, which are shown for highlighting specific aspects and embodiments of the present invention. It is obvious that other aspects can be used and that structural or logical changes in the illustrated embodiments are possible without leaving the scope of the present invention. The following description of the figures is therefore to be understood as non-limitative. Shown are:

FIG. 1 is a schematic illustration of an exemplary turbomachine for an aircraft propulsion drive in accordance with the present disclosure;

FIG. 2 a is schematic illustration of an exemplary embodiment of a heat exchanger of an exemplary turbomachine in accordance with the present disclosure;

FIG. 3 is a schematic sectional illustration of an exemplary embodiment of a heat exchanger of an exemplary turbomachine in accordance with the present disclosure;

FIG. 4 is a further schematic sectional illustration of an exemplary embodiment of a heat exchanger of an exemplary turbomachine in accordance with the present disclosure;

FIG. 5a, 5b are respective views of flow channels of a further exemplary embodiment of a heat exchanger of an exemplary turbomachine in accordance with the present disclosure;

FIGS. 6a-6c are respective views of flow channels of a further exemplary embodiment of a heat exchanger of an exemplary turbomachine in accordance with the present disclosure; and

FIG. 7a, 7b are schematic sectional views of a first exemplary embodiment and of a second exemplary embodiment, respectively, of a flow channel with a flow element of a heat exchanger of an exemplary turbomachine in accordance with the present disclosure.

### DESCRIPTION OF THE INVENTION

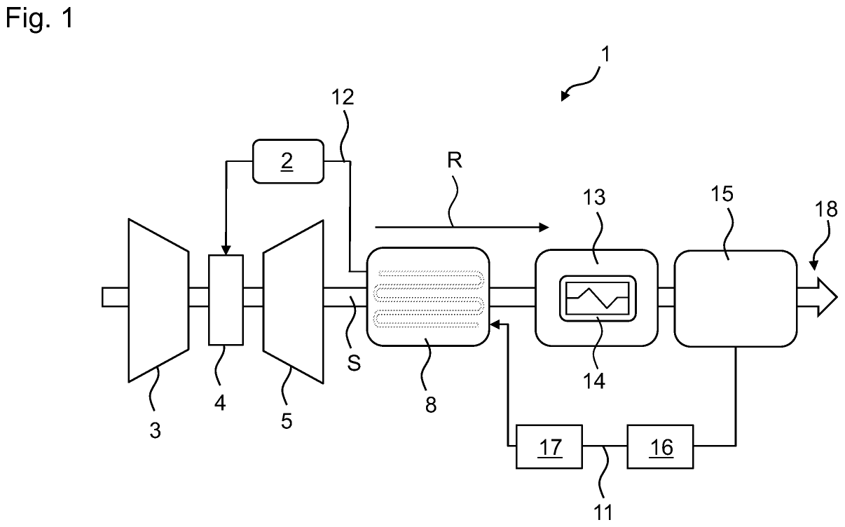

FIG. 1 shows a turbomachine 1 in accordance with the invention for an aircraft propulsion drive in a schematic illustration.

The turbomachine 1 is designed as a turbofan engine, for example, and has a compressor 3, a combustion chamber 4, and a turbine 5, through which a gas flow S can stream in a flow direction R or through which the gas flow S can stream during operation of the turbomachine 1. Downstream of the turbine 5 in the flow direction R, the turbomachine 1 has a heat exchanger 8, which is set up to produce steam from water by energy of the gas flow S.

This steam can be fed via a steam feed 12, in particular together with a fuel, into the gas flow S for combustion in the combustion chamber 4. The steam feed 12 can have a mixing chamber 2 of a fuel processing device, in which fuel is introduced and to which the steam introduced there can be fed, whereby the fuel can vaporize. Accordingly, it is possible to form a mixture from the steam and the fuel and to feed it to the combustion chamber 4 of the turbomachine 1. In many embodiments, the steam can also be fed to the gas flow S prior to and/or in the combustion chamber 4.

In relation to a global flow direction R of the gas flow S illustrated by the arrow, the gas flow S passes initially the compressor 3, the combustion chamber 4, and the turbine 5. After the turbine 5, the gas flow S can also be referred to as an exhaust gas flow of the turbomachine 1. This (exhaust) gas flow S can stream from the turbine 5 into the heat exchanger 8, downstream of which a cooling device 13 and a water separating device 15 are arranged in the flow direction of the gas flow S.

The cooling device 13 can have a condenser 14 for cooling with surrounding air in order to make possible a separation of steam and/or water present in the gas flow S. Arranged downstream of the cooling device 13 in the present exemplary embodiment is a water separating device 15, which can be designed as a droplet separator in order to collect the water. The residual gas flow S can exit the turbomachine 1 via an outlet 18 and, in particular, can be discharged to the surroundings.

The separated water can be fed via an optionally present water processing system 16, for example, to a water reservoir 17, where it can be available for a further use. By a feeding device 11, the water can be made available to the heat exchanger 8 in order to produce steam, which can be fed to the gas flow S in the region of the combustion chamber 4.

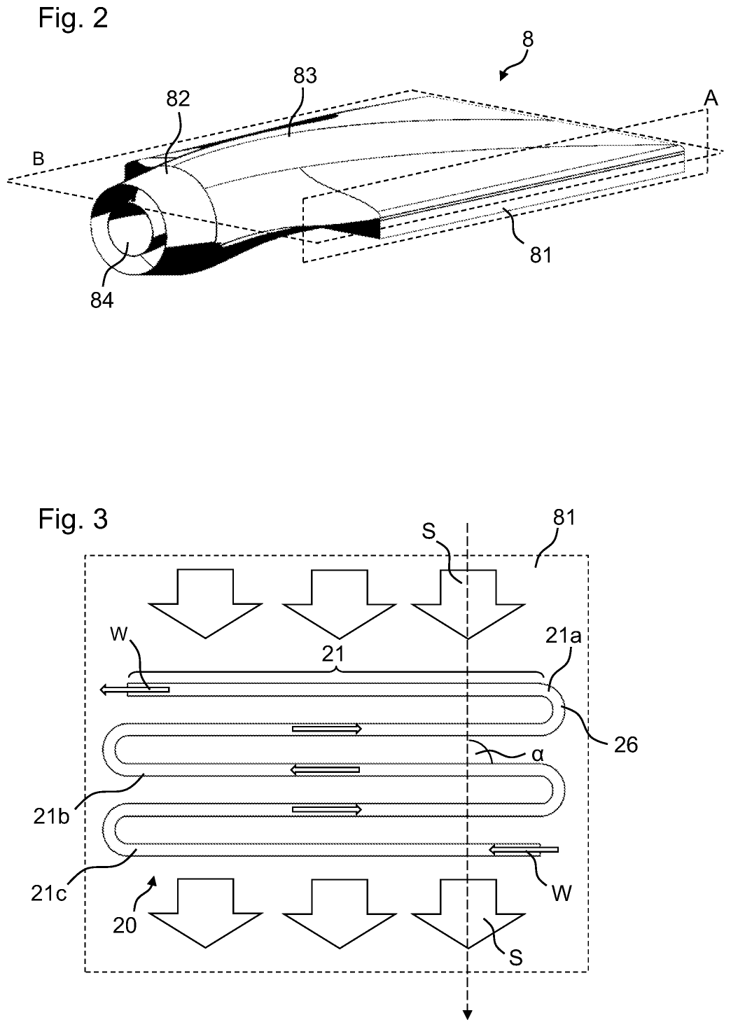

Exemplary embodiments of the heat exchanger 8 are described in detail below in conjunction with FIGS. 2 to 7b.

FIG. 2 shows a perspective illustration of a first exemplary embodiment of a heat exchanger 8, such as one that can be provided in a turbomachine 1 of FIG. 1.

The exemplary heat exchanger 8 is essentially planar in construction and has a heat-exchange region 81 extending in a plane B, in which at least one flow channel through which water can flow is arranged and around which the gas flow can stream at an angle. In particular, the heat exchanger 8 can also have a plurality of heat-exchange regions 81.

At an end facing the turbine 5, the heat exchanger 8 has a collecting tube 82, by which the gas flow can be carried from the turbine 5 to the at least one flow channel or to the heat-exchange region 81. The collecting tube 82 or the heat exchanger 8 has a diverting device 83, in particular in the form of a curvature in the collecting tube 82, by which the gas flow S can be diverted, so that the gas flow can stream around the at least one flow channel at an angle of 90° and, in this way, a heat transfer is made possible between the gas flow and the water.

FIG. 3 shows a schematic illustration of a sectional plane A from FIG. 2 of an exemplary embodiment of a heat-exchange region 81 of a heat exchanger 8, such as one that can be formed in a turbomachine 1 of FIG. 1 or in a heat exchanger 8 of FIG. 2.

In the heat-exchange region 81, a flow channel 20 extends essentially parallel to the planar extension of the heat-exchange region 81 and parallel to the flow direction R of the turbomachine 1 and water W can flow through it. The flow channel 20 hereby has at least two-here, five-sections 21 arranged parallel with respect to one another, which can extend in a plurality of parallel arrangement planes. The sections 21 can hereby be connected by a connecting device 26 in a one-to-one arrangement for carrying fluid. The gas flow S can stream through the sections 21 one after the other—here from top to bottom—at an angle α—here an angle of 90°. At least two of these sections 21 have hereby different materials.

In an embodiment, a section 21a, arranged further upstream in the direction of the gas flow S, of the at least one flow channel 20, has a material with a higher density than a section 21b, 21c arranged further downstream. When the gas flow S enters the heat exchanger 8 or heat-exchange region 81, it has the highest temperature and thus can release the most energy or heat to the water or to the steam in region of the at least one flow channel 20 that faces the entrance. In this region, the at least one flow channel 20 or the sections 21a arranged there is or are subject to a higher thermal load than sections 21b, 21c that are further away. Through the use of materials of higher density for the sections 21a with higher thermal loads, it is possible to increase a robustness and prolong a lifetime of the sections 21a or of the flow channel 20.

In addition, a section 21c of the at least one flow channel 20 arranged further upstream can have a material with a lower density than a section 21a, 21b arranged further downstream. In this way, the sections 21 of the flow channel 20 that are arranged in regions of the heat exchanger 8 or of the heat-exchange region 81 and are exposed to a lower gas flow temperature can have materials of lower density. Owing to the lower material densities, such sections 21c have a lower weight relative to sections 21a, 21b with materials of higher density, as a result of which a total weight of the sections 21 and thus of the heat exchanger 8 and/or of the turbomachine 1 can be reduced.

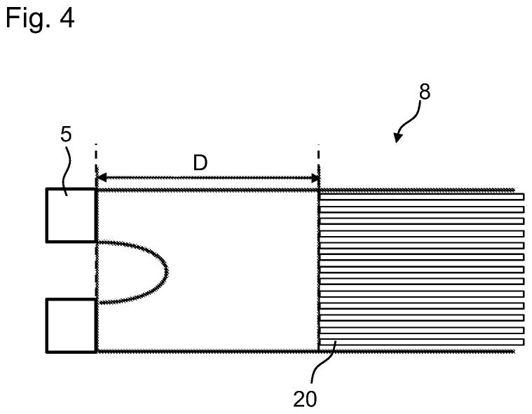

Illustrated in FIG. 4 is a schematic sectional illustration in a plane B of the heat exchanger 8 from FIG. 2.

The heat exchanger 8 has a plurality of flow channels 20, which are arranged parallel with respect to one another and through which the water W can flow, each of which can have a plurality of sections 21 arranged in parallel planes. The gas flow S can stream around the flow channel 20 in a direction perpendicular to a plane of the drawing in order to release energy to the water W. The gas flow S can hereby stream through all of the flow channels 20, in particular homogeneously or uniformly, in order to produce steam.

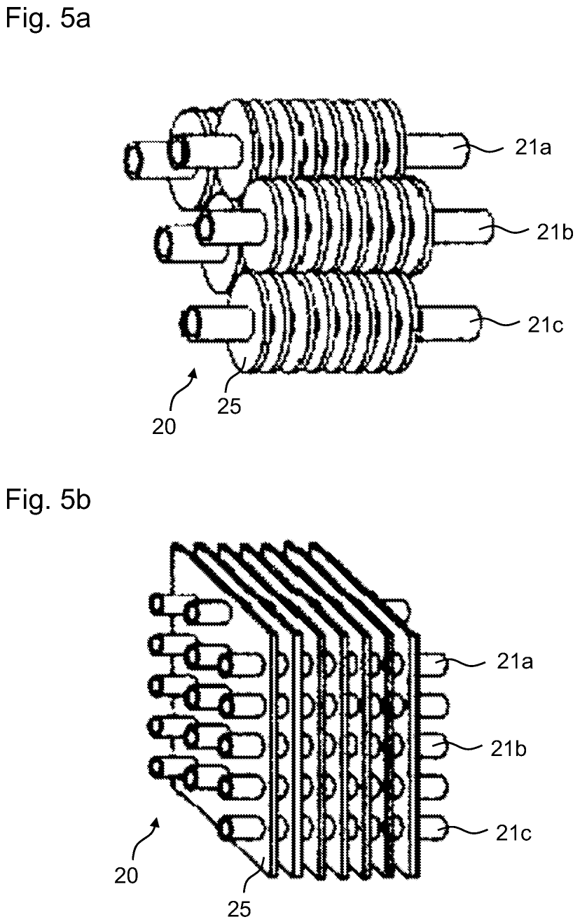

FIGS. 5a and 5b show respective views of the flow channels 20 or sections 21 of the flow channels 20 that have the structural elements 25.

In the illustration of FIG. 8a, a first exemplary embodiment of a structural element 25 is depicted in the form of a lamella, which is arranged on a surface of the at least one flow channel 20 facing the gas flow S. This flow element 28 is set up to enlarge the surface of the flow channel 20 or of the respective sections 21a, 21b, 21c in order to increase an efficiency of the heat transfer.

In the illustration of FIG. 5b, a second exemplary embodiment of a structural element 25 is depicted in the form of a lamella that connects the flow channels 20 or the sections 21a, 21b, 21c of the flow channels 20. In the illustrated exemplary embodiment, a plurality of such lamellae 25 are arranged parallel and uniformly spaced apart with respect to one another. In this way, a surface for the beat exchange can be enlarged and a heat exchange between the sections 21a, 21b, 21c can be made possible.

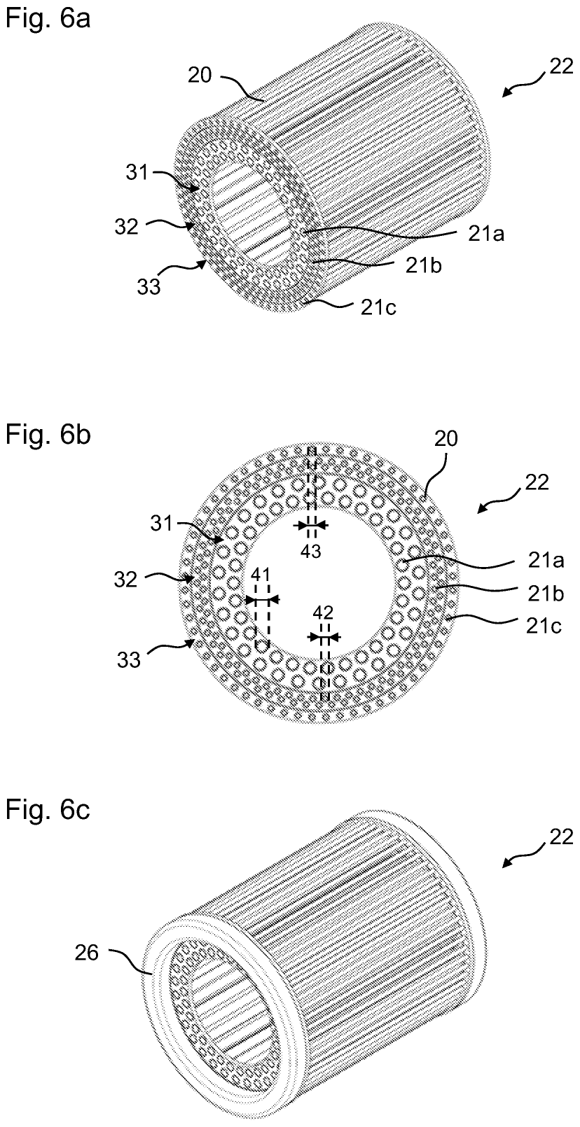

FIGS. 6a to 6c show respective views of flow channels 20 in an exemplary axis-symmetrical arrangement.

FIG. 6a shows a perspective illustration of an exemplary embodiment of a flow channel arrangement 22. The flow channels 20 hereby have three sections 21a, 21b, 21c arranged parallel with respect to one another, which are each arranged in concentric arrangement planes 31, 32, 33. The sections 21a, 21b, 21c of the respective planes 31, 32, 33 hereby have different numbers of flow channels 20 or sections 21 of the flow channels 20 and have different inner cross sections 41, 42, 43. At least two of the sections 21a, 21b, 21c have different materials.

In other exemplary embodiments, the sections 21a, 21b, 21c and/or the flow channels 20 can be arranged in one arrangement plane or in a plurality of arrangement planes 31, 32, 33 extending parallel in a plane or, in the embodiment of FIGS. 6a to 6c, arranged concentrically with respect to one another.

FIG. 6b shows a front view the flow channel arrangement 22 from FIG. 6a. By way of example, the sections 21a and 21b of the arrangement planes 31 and 32 have different inner cross sections 41 and 42 and the number of the first sections 21a differs from the number of the second sections 21b. The sections 21b and 21c of the arrangement planes 32 and 33 have the same inner cross sections 42 and 43 and the number of the second sections 21b differs from the number of the third sections 21c. In addition, at least two of the sections 21a, 21b, 21c have different materials. By way of such a different design of the inner cross sections 41, 42, 43, the number, and the materials of various sections 21, it is possible to improve a heat transfer in a heat exchanger 8.

In addition, a tubular wall thickness of a section 21a, 21b, 21c can be determined depending on an inner cross section 41, 42, 43 and/or a used material in order to be able to achieve a further optimization of a heat exchange or a reduction in weight.

FIG. 6c shows the perspective illustration of the exemplary embodiment of a flow channel arrangement 22 from FIG. 6a, whereby the sections 21c and the sections 21b of the flow channel 20 are connected by a connecting device 26. By such a connecting device, the sections 21a, 21b, 21c, which have different materials, can be connected. The connecting device 26 set up here to divert water W from the sections 21b of the flow channels 20 into the adjacent sections 21c of the flow channels 20. In the present exemplary embodiment, the connecting device 26 is set up to collect water W from the sections 21b of the arrangement plane 32 in a plenum and to carry it to the sections 21c of the arrangement plane 32. In this way, it is possible to divert the water W in spite of different materials and number of sections 21b and 21c.

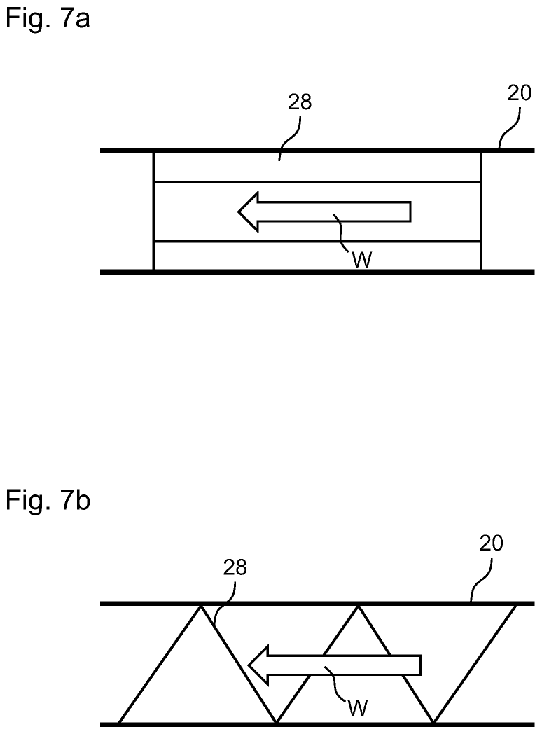

FIGS. 7a and 7b each show side views of flow channels 20 that have a flow element 28.

In the illustration of FIG. 7a, a first exemplary embodiment of a flow element 28 is designed in the form of an insert, which is arranged in the inner cross section of the flow channel 20 through which the water W can flow. This flow element 28 is set up to reduce the inner cross section of the flow channel 20 at least in sections in order to improve, by the use of altered surface structures or by the way in which the flow is carried, the heat transfer from the channel walls to the water.

In the illustration of FIG. 7b, a second exemplary embodiment of a flow element 28 is designed in the form of a lattice structure, which is arranged in the cross section of the flow channel 20 through which a flow occurs, in particular in a vaporization region of the flow channel 20. Such a lattice structure 28 can result in the creation of turbulences and, in particular, the droplets present in a water (steam) flow can be brought onto a wall of the flow channel 20 or onto a part of the flow element 28 connected to the wall in a thermally conductive manner in order to improve the supply of heat.

What is claimed is:

1. A turbomachine for an aircraft propulsion drive, comprising:
a compressor, through which a gas flow streams in a flow direction of the turbomachine,
a combustion chamber,
a turbine, and
a heat exchanger downstream of the turbine,
wherein the heat exchanger is configured and arranged to produce steam from water by energy from the gas flow, which is fed to the gas flow for combustion with fuel in the combustion chamber,
wherein the heat exchanger has at least one flow channel, through which the water flows and which has at least two sections arranged parallel to one another,
wherein the gas flow streams at an angle through the at least two sections, which comprise different materials.

2. The turbomachine according to claim 1, wherein the gas flow streams around the at least two sections, one after the other, at an angle.

3. The turbomachine according to claim 1, wherein a section of the at least one flow channel arranged further upstream in a flow direction of the gas flow comprises a material with a higher density than a section arranged further downstream.

4. The turbomachine according to claim 1, wherein the at least one flow channel has at least one structural element on its surface facing the gas flow.

5. The turbomachine according to claim 1, wherein at least two flow channels are connected to one another by at least one structural element.

6. The turbomachine according to claim 1, wherein at least two sections of the at least one flow channel have different inner cross sections.

7. The turbomachine according to claim 1, wherein at least two sections of a flow channel arranged parallel with respect to one another are in fluid connection by a connecting device.

8. The turbomachine according to claim 7, wherein the connecting device is configured and arranged to divert water from a section of the flow channels into at least one adjacent section of the flow channels.

9. The turbomachine according to claim 1, wherein a number of first sections differ from a number of second sections of the heat exchanger.

10. The turbomachine according to claim 1, wherein the at least one flow channel has a flow element.
